(19) United States
(12) Patent Application Publication
(10) Pub. No.: US 2006/0064719 A1
(43) Pub. Date: Mar. 23, 2006

(54) Simultaneous video input display and selection system and method

(76) Inventor: John J. Youden, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/943,580

(22) Filed: Sep. 17, 2004

(51) Int. Cl. H04N 5/445

(52) U.S. Cl. 725/38

(57) ABSTRACT

A method of selecting video content to be displayed from among a plurality of video inputs includes initiating a video input selection mode of operation, simultaneously displaying video content currently being presented on all video inputs, and selecting the video content to be displayed from among the displayed video content for all the video inputs.

### BACKGROUND OF THE INVENTION

In current home theater systems, a viewer must select a desired video input to display video content being presented on that input on a television, flat-panel display, or other type of video display device. Typically, the desired video input is selected using a remote control. FIG. 1 is a block diagram illustrating a portion of a typical home theater system 100 including a remote control 102 having a plurality of buttons 104a-f for selecting a desired video input source. For example, the button 104a selects a digital video disc (“DVD”) video input source, 104b selects a TV video input source, and so on, with buttons 104d-f being generic video inputs designated V1-V3 and to which other generic video input devices may be coupled, such as a personal video recorder (PVR) like a TiVo PVR. The system 100 further includes a television 106 coupled to a DVD player 108, cable box 110, video cassette recorder (VCR) 112, PVR 114, and camcorder 116 through video inputs DVD, TV, VCR, V2, and V1, respectively.

In operation of the home theater system 100, to display desired video content a viewer utilizes the remote control 102 to select the desired video input and thereafter controls the associated electronic component and possibly other components to play the desired video content. For example, assume a first viewer depresses the TV button on the remote control 102 to select the TV video input on the television and thereafter controls the cable box to view desired cable television channels on the television 106. Now assume a subsequent viewer wants to watch a DVD. This subsequent viewer must not only put the desired DVD in the player 108 and activate the player to play the DVD, but must also depress the DVD button on the remote control 102 to select the DVD video input and play the video content of the DVD on the television 106.

The process described for selecting the cable box 110 as the video input source displayed on the television 106 applies to selecting any of the video input sources 108-116 coupled to the television 108. While this process may be straightforward for many, a lot of viewers find this process frustrating and confusing. For example, with the configuration of the system 100 a viewer must remember to not only control the desired video input source 108-116 but to also select the corresponding video input on the television 106 in order to display the desired video content on the television. Moreover, in some situations the viewer must remember which video input is to be selected for a desired video input source 108-116. In the system 100, for example, a viewer must remember that the PVR 114 is coupled to video input V2 and thus that video input V2 must be selected using the remote control 102 to display video content from the PVR on the television 106.

Another typical example that leads to frustration of viewer is the need to tune the television 106 to a predetermined station in order to view video on an RF input. For example, in another common configuration for the system 100 the VCR 112 is coupled to the TV video input and the cable box 110 is coupled through the VCR to the television 106. With this type of configuration, the television typically must be tuned to channel 3 or channel 4 in order to receive a selected station from the cable box 110 or to view the content of a VCR tape being played on the VCR 112. Thus, if the selected station of the television 106 is not the correct channel, either channel 3 or channel 4, all that will be displayed on the television is “snow.” For example, if the television 106 is tuned to channel 7, meaning channel 7 is selected, then a viewer may be confused as to why only snow is displayed and the viewer is not able to view the video content being presented on channel 7. To view the video content of channel 7, a viewer must tune the television 106 to the proper one of channel 3 or 4 and thereafter control the cable box to select channel 7. This is a confusing situation for many viewers.

There is a need for simplifying the way in which a viewer selects video input sources that may be displayed on a television or other video display device.

### SUMMARY OF THE INVENTION

According to one aspect of the present invention, a method of selecting video content to be displayed from among a plurality of video inputs includes initiating a video input selection mode of operation, simultaneously displaying video content currently being presented on all video inputs, and selecting the video content to be displayed from among the displayed video content for all the video inputs.

### BRIEF DESCRIPTION OF THE DRAWINGS

FIG. 1 is a block diagram illustrating a portion of a conventional home theater system for describing conventional methods of selecting a desired video input source to be displayed by the system.

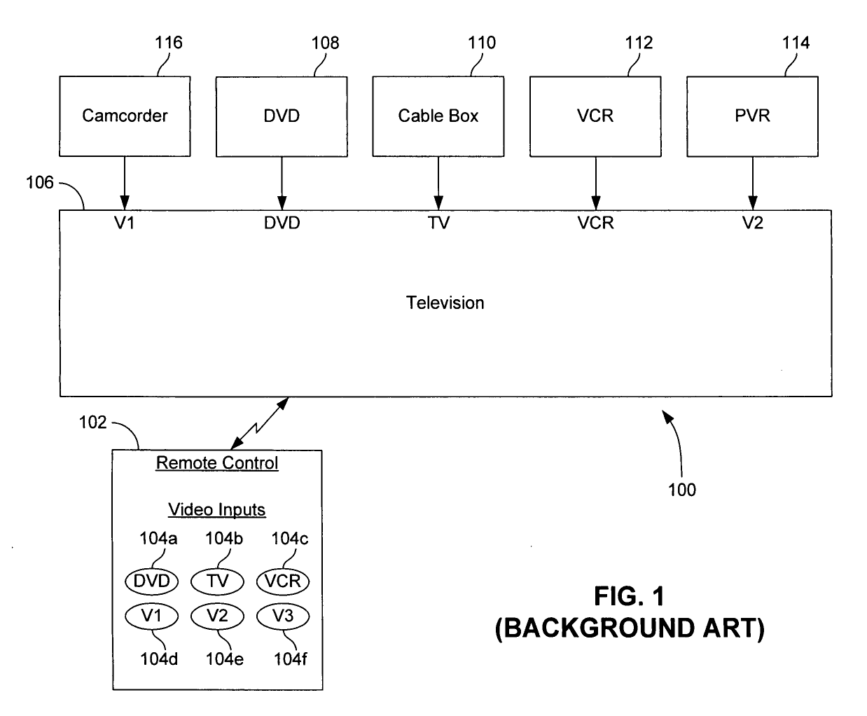

FIG. 2 is a functional block diagram of a video input display and selection system that displays the current video content being presented on all available video inputs of a video display generating device and allows a viewer to select a desired source from among the displayed sources according to one embodiment of the present invention.

FIG. 3 is a flowchart illustrating a display and selection process executed by the video input display and selection system of FIG. 2 according to one embodiment of the present invention.

FIG. 4 is sample of a video screen displayed on the video display generating device of FIG. 2 during execution of the process of FIG. 3 according to one embodiment of the present invention.

### DETAILED DESCRIPTION OF PREFERRED EMBODIMENTS

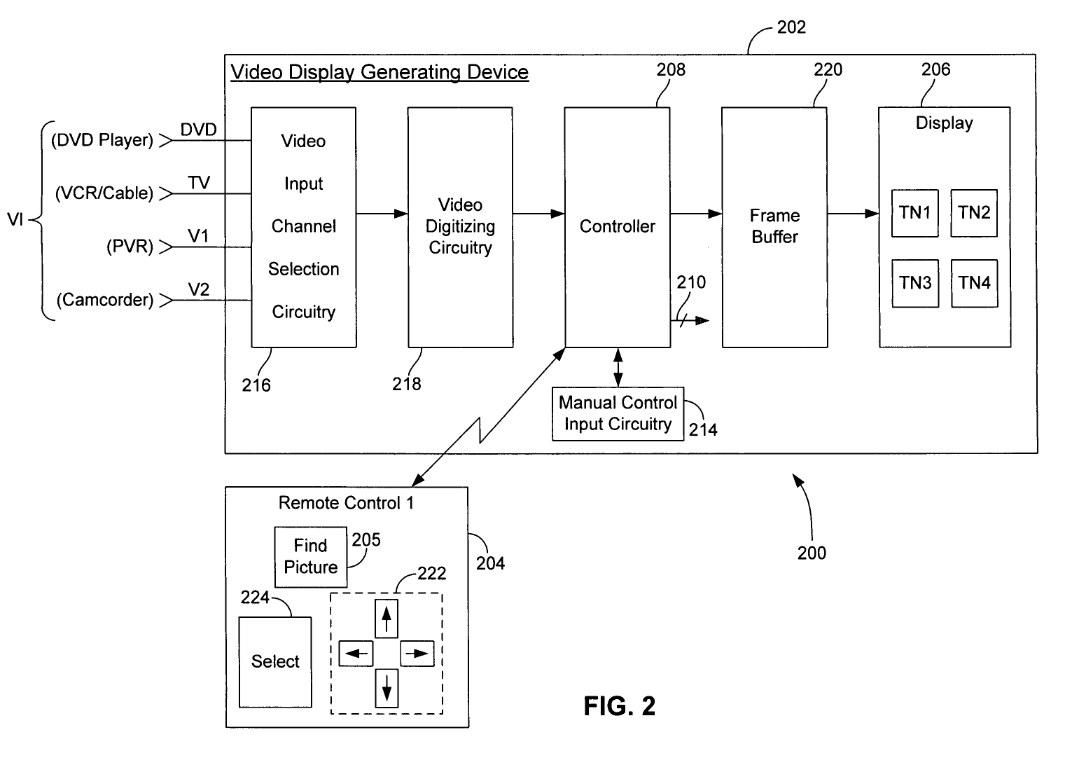

FIG. 2 is a functional block diagram of a video input display and selection system 200 that displays the current video content being presented on all available video inputs VI of a video display generating device 202 and which allows a viewer to select a desired video input source from among the displayed sources according to one embodiment of the present invention. Utilizing a remote control 204, a viewer depresses a “find picture” button 205 to activate a video input source selection mode of operation during which the video display generating device 202 displays a number of video input thumbnails TN1-TN4 on a video display 206 of the device. Each video input thumbnail TN1-TN4 corresponds to a window displayed on the display 206 that contains a captured frame of video content currently being presented on a corresponding one of the video inputs VI, which include video inputs DVD and TV along with generic video inputs V1 and V2 in the embodiment of FIG. 2. The viewer can thus see the video content currently available on each video input VI and can thereafter utilize the remote control 204 to select a desired one of the video inputs and display the corresponding video content on the display 206, as will be described in more detail below. In this way, the device 202 and remote control 204 allow a viewer to more easily select desired video content since all the viewer need do is select the desired content from the current content being displayed for each of the video inputs VI of the device. The viewer need not know what video source is connected to which video input VI but merely activates the video input source selection mode of operation and then selects the desired content.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail below to avoid unnecessarily obscuring the present invention.

The video display generating device 202 may be any type of device that displays video images, such as a television, a personal computer, or a personal video recorder like a TiVo PVR, and may alternately be referred to as a television in the following description simply for ease of description. The video display generating device 202 includes a controller 208 that generates a plurality of control signals 210 to control the operation of other components in the device. The controller 208 also receives control signals from the remote control 204 over a wireless link 212, and in response to these control signals the controller controls operation of other components in the device 202 as well as the overall operation of the device. Alternatively, the controller 208 receives control signals from a manual control input circuitry 214 which allows a viewer to apply inputs directly to the device 202 instead of through the remote control 204.

The video display generating device 202 further includes video input channel selection circuitry 216 that receives video signals applied on the video inputs VI. In the embodiment of FIG. 2, the channel selection circuitry 216 receives video signals from four video inputs VI, namely a DVD video input, a TV video input, a first generic video input V1, and a second generic video input V2 as previously mentioned. The DVD, TV, V1, and V2 video inputs collectively form the video inputs VI of the device 200. By way of example, a particular video input source is indicated in parentheses as supplying the corresponding video signal to each of the DVD, TV, V1, and V2 video inputs. More specifically, the DVD video input receives a video signal from a DVD player, the TV video input is an RF video input of the device 202 and receives a video signal from a VCR or a cable-television box, the V1 video input receives video signal from a personal video recorder (PVR), and the V2 video input receives a video signal from a camcorder. The term video input VI may be any type of video input VI, such as a conventional analog video input like a composite, component, or S-video input, and may also be digital video input that receive digital signals such as signals over an IEEE 1394 link, for example, and may also be an RF video input. Accordingly, the video inputs VI of the device 202 can be any type of video input such as the types just mentioned but including others as well.

In response to the control signals 210 from the controller 208, the channel selection circuitry 216 applies the video signal from a selected one of the video inputs VI to video digitizing circuitry 218. The video digitizing circuitry 218 digitizes the analog video signal from the channel selection circuitry 216 to generate a corresponding digital video signal. The digitizing circuitry 218 provides this digital video signal to the controller 208 which, in turn, stores the digital video signal in a frame buffer 220. Under control of the controller 208, the digital video signal stored in the frame buffer 220 is thereafter supplied to the display 206 which generates a corresponding visual image from the digital video signal. The digital video signal stored in the frame buffer 220 consists of a series of frames, where a frame corresponds to the video data for a given video image to be generated on the display 206. The frames are sequentially retrieved from the frame buffer 220 and corresponding video images sequentially generated on the display 206. The display 206 may be a cathode ray tube (CRT), liquid crystal display (LCD), plasma screen, or any other suitable type of video display.

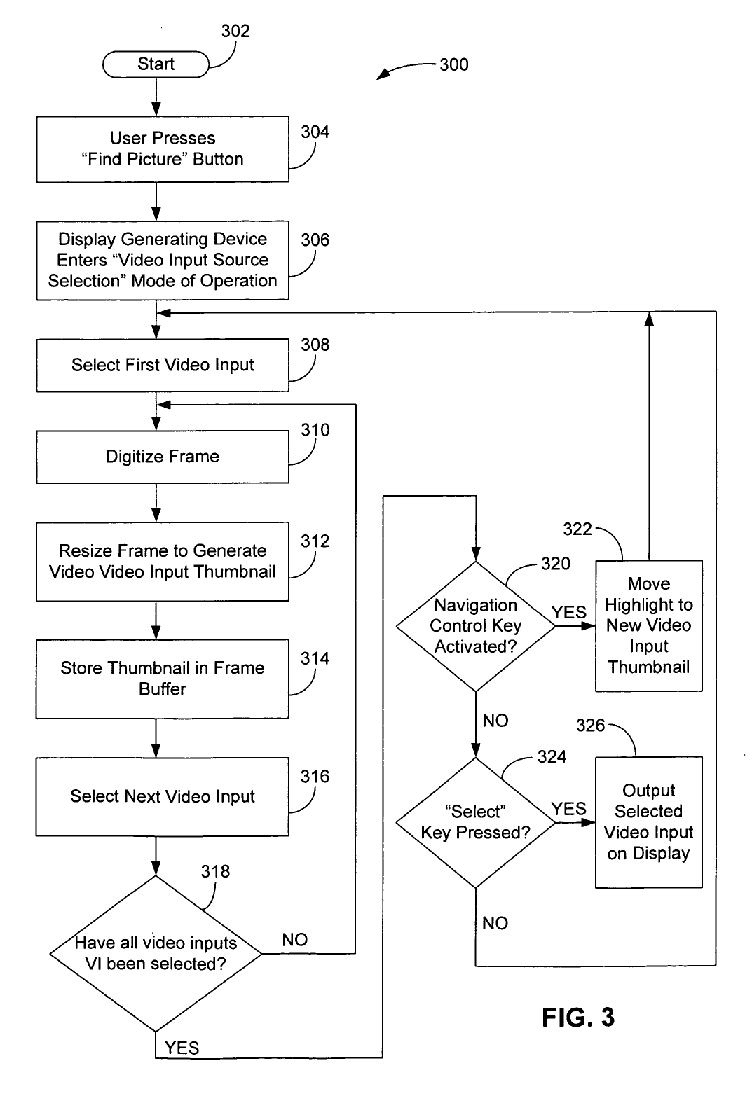

The overall operation of the video input display and selection system 200 of FIG. 2 will now be described in more detail with reference to FIGS. 2 and 3, where FIG. 3 is a flowchart illustrating a display and selection process 300 executed by the video input display and selection system 200 according to one embodiment of the present invention. The process begins in step 302 and proceeds immediately to step 304 in which a viewer depresses the find picture button 205 on the remote control 204 to initiate the video input source selection mode of operation. In response to the button 205 being depressed, the remote control 204 communicates a corresponding control signal over the link 212 to the controller 208. At this point, the process proceeds to step 306 and the controller 208 places the video display generating device 202 in the video input source selection mode of operation in response to this received control signal.

During the video input source selection mode, the video display generating device 202 displays the video content currently being presented on each of the video inputs VI and allows a viewer to select the desired video content using the remote control 204, as will be explained in more detail below. From step 306, the process goes to step 308 and the controller 208 applies the control signals 210 to the channel selection circuitry 216 to select a first one of the video inputs VI. The process then goes to step 310 in which the video digitizing circuitry 218 digitizes a frame of the current video signal being presented on the selected video input VI. For example, assume that the controller 208 initially causes the channel selection circuitry 216 to provide the video signal on the DVD video input to the digitizing circuitry 218. In this situation, the digitizing circuitry 218 digitizes a frame of the current video signal on the DVD video input.

The process goes from step 310 to step 312 in which the video digitizing circuitry 218 provides the digitized frame to the controller 208 which, in turn, resizes this frame to generate a video input thumbnail TN to be displayed on the display 206. The video input thumbnail TN in this case corresponds to a window displayed on the display 206 that displays the video content currently being presented on the DVD video input. From step 312, the process goes to step 314 and the controller 208 stores the video input thumbnail TN in the frame buffer 220. Please note that the term video input thumbnail TN may be used to refer both to the window displayed on the display 206 as well as the digital data corresponding to the resized digitized frame stored in the frame buffer 220. The digitized frame is resized to generate the corresponding video input thumbnail TN so that multiple thumbnails TN can be simultaneously displayed on the display 206, allowing a viewer to simultaneously view the video content available on all video inputs VI, as will be described in more detail below. At this point, the video input thumbnail TN stored in the frame buffer 220 is supplied to the display 206 which, in turn, displays the video input thumbnail.

From step 314, the process goes to step 316 and the controller 208 applies control signals 210 to the channel selection circuitry 216 to select a next one of the video inputs VI. In the present example, assume that the next selected video input VI is the TV video input. The process then goes to step 318 and the controller 208 determines whether all the video inputs VI have already been selected. Because only the DVD and TV video inputs have been selected at this point, the determination in step 318 is negative and the process returns to step 310. The process then repeats steps 310-314 for the video signal on the TV video input. Thus, when step 314 is executed for the video signal on the TV video input, the corresponding thumbnail TN is stored in the frame buffer 220 and the display 206 now displays the thumbnails corresponding to the DVD video input and the TV video input. The process then goes to step 316 and the next video input VI is selected, which in this situation is the V1 video input. Because the V1 video input is not the last video input, the determination in step 318 will once again be negative and the process will return to step 310. The process continues executing steps 310-316 to sequentially generate video input thumbnails TN for each video input VI of the video display generating device 202.

Once all video inputs VI have been selected, meaning that a corresponding thumbnail TN for the input has been stored in the frame buffer 220 and displayed on the display 206, the determination in step 318 is positive and the process proceeds to step 320. The step 320 signals the start of the selection portion of the display and selection process 300. In the selection portion of the process, a viewer looks at the thumbnails TN on the display 206 to determine the video content available for display on the device 202. The thumbnails TN illustrate all video content currently available for the device 202. From this available video content, the viewer selects a desired one of the thumbnails TN on the display 206 to thereby display the corresponding video content, as will now be described in more detail.

Before describing the selection portion of the process, it should be noted that once the thumbnails TN for all video inputs VI are displayed on the display 206 one of these thumbnails will initially be “highlighted” in some manner. The highlighted thumbnail TN designates the thumbnail that may currently be selected by a viewer, as will become clearer from the following description. The thumbnail TN that is initially highlighted may vary, and in the present example assume the thumbnail corresponding to the DVD video input is the initially highlighted thumbnail.

Returning now to the current step of the process, which is step 320, the process determines whether a navigation control key 222 on the remote control 204 has been activated. For example, as shown in FIG. 2 the navigation control keys may include a group of arrow keys and in this situation step 320 determines whether one of these arrow keys has been depressed. If the determination in step 320 is positive, the process goes to step 322 and a different thumbnail TN is highlighted in response to the activated navigation control key. In the arrow keys embodiment, if the right arrow key was depressed the next thumbnail TN to the right of the currently highlighted thumbnail would be highlighted. A viewer in this way utilizes the navigation control keys 222 to change the highlighted thumbnail TN on the display 206. For example, if the thumbnail TN1 is associated with the DVD video input, which is the initially highlighted thumbnail, and the viewer instead wants to watch what is being presented on the input associated with thumbnail TN2 (assume the TV video input), then he or she depresses the right arrow button to change the highlighted thumbnail from TN1 to TN2. Many other embodiments of the navigation control keys 222 are possible, of course. In another embodiment, for example, the find picture button 205 is also used as the navigation control keys 222. Once the find picture button 205 is initially depressed to initiate the video input source selection mode of operation, each subsequent time the button is depressed a next one of the thumbnails TN is highlighted.

If the determination in step 320 is positive, meaning a navigation control key 222 on the remote control 204 has been activated, the process goes to step 322 and the appropriate thumbnail TN is highlighted in response to the activated navigation control key. From step 322, the process goes back to step 308 and steps 308-320 are once again executed as previously described to refresh or update the video content being displayed in each of the thumbnails TN on the display 206. Once all thumbnails TN have been updated, the determination in step 318 is again positive and the process returns again to step 320.

When the determination in step 320 is negative, no navigation control key 222 on the remote control 204 has been depressed and the process goes to step 324. In step 324, the process determines whether a select button 224 on the remote control 204 has been depressed. A viewer depresses the select button 224 to select the highlighted thumbnail TN and thereby display the video content of the video input VI corresponding to the thumbnail on the display 206. Thus, if the determination in step 324 is positive, the process goes to step 326 and the video content of the video input VI corresponding to the highlighted thumbnail TN is displayed on the display 206 for the viewer to watch. When the determination in step 324 is negative, the process goes back to step 308 and steps 308-320 are once again executed to refresh or update the video content being displayed in each of the thumbnails TN on the display 206.

The video input display and selection system 200 enables a viewer to easily select desired video content to be watched on the video display generating device 202 without any knowledge of what video input source is connected to which video input VI. Instead, all a viewer needs to do is simply look at the video input thumbnails TN on the display 206 and select the desired video content based upon the content being presented. No knowledge of the configuration of the system 200 is required. For example, to watch a DVD all a viewer need do is insert the DVD into a DVD player and start the DVD playing. The viewer then depresses the find picture button 205 on the remote control 204 to initiate the video input source selection mode of operation of the system 200. One of the thumbnails TN will display video content corresponding to the DVD being played and all the viewer needs to do is highlight and select this thumbnail to display this video content on the display 206.

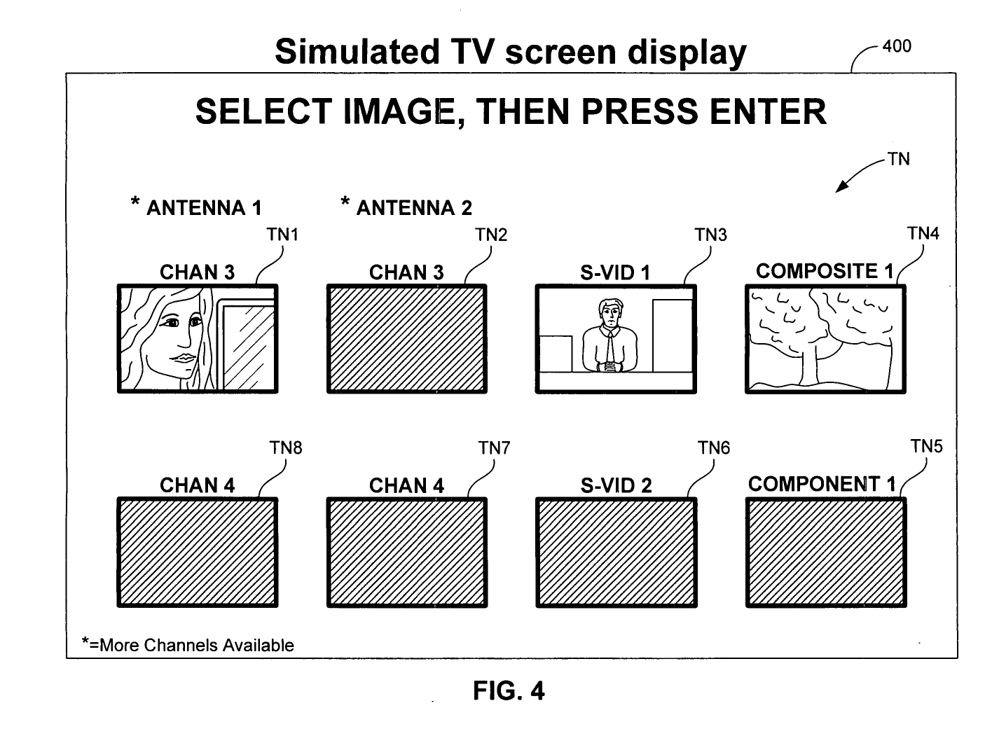

FIG. 4 is sample of a video screen 400 displayed on the video display 206 of the video display generating device 202 of FIG. 2 during execution of the process of FIG. 3 according to one embodiment of the present invention. The video screen 400 includes 8 video input thumbnails TN, which are designated TN1-TN8 in FIG. 4. In the embodiment of FIG. 4, identification information is also displayed on the screen 400 for each of the thumbnails TN1-TN8 to provide a viewer with information about which video input VI of the video display generating device 202 of FIG. 2 is associated with each thumbnail. In the example of FIG. 4, the device 202 includes two RF video inputs designated ANTENNA 1 and ANTENNA 2, two S-video inputs designated S-VID1 and S-VID2, a composite video input COMPOSITE 1, and a component video input COMPONENT 1. One skilled in the art will understand functionality and operation of an S-video input S-VID1, S-VID2, composite video input COMPOSITE 1, and component video input COMPONENT 1, and thus for the sake of brevity these inputs will not be described in more detail.

For RF video inputs, namely ANTENNA 1 and ANTENNA 2, the screen 400 shows that in one embodiment both channels 3 and 4 could be displayed as separate thumbnails TN for each such input. The thumbnails TN1 and TN3 show what is being presented on channels 3 and 4, respectively, for the ANTENNA 1 RF input while the thumbnails TN2 and TN7 show what is being presented on channels 3 and 4, respectively, for the ANTENNA 2 RF input. In this way, if a VCR is connected to one of the ANTENNA 1 or ANTENNA 2 inputs, the viewer need not know whether the VCR is set to provide a signal on channel 3 or channel 4 and thus need not worry about the channel to which the television 202 should be tuned. Notice that with the system 200, all video inputs VI are displayed simultaneously on the screen 400 whether there is currently video content being presented on the input or not. Thus, channels 4 for the ANTENNA 1 input, channels 3 and 4 of the ANTENNA 2 input, along with the S-VID 2 and COMPONENT 1 inputs are displayed on screen 400 even though no video content is being presented on these inputs. This allows a viewer to visually see all the available video inputs VI and where identification information is associated with each thumbnail TN1-TN8, as in FIG. 4, the viewer can determine configuration information from this screen. For example, if the viewer wanted to connect a DVD player to S-VID 1 but instead connected it to S-VID 2, the viewer could quickly determine this from the screen 400 and change the physical interconnection of the DVD player to the desired video input VI.

Because additional channels of video are available for RF video inputs, namely the ANTENNA 1 and ANTENNA 2 inputs, information notifying a viewer of this fact can also be displayed for these inputs. In the screen 400, the device 202 displays an asterisk “*” for each RF input, and at the bottom of the screen indicates that the “*” indicates that more channels of video content are available from these inputs. Other information may of course be displayed on the screen 400 in other embodiments of the invention. For example, instructions that tell a viewer what buttons to activate on the remote control to select a desired thumbnail TN could also be displayed on the screen 400. Also note that the term “highlight” is used generally herein, and indicates any means of distinguishing one of the thumbnails TN1-TN8 from the other thumbnails. In FIG. 4, the thumbnail TN1 is highlighted, which means that the video content corresponding to this thumbnail may be selected by the viewer. Other means of “highlighting” or distinguishing a particular thumbnail TN could of course be used, such as text that switches from one thumbnail to the next in response to the navigation control keys 222 on the remote control 204, an asterisk “*” or other symbol being displayed next to a thumbnail, flashing the content in one of the thumbnails, and so on. Also, in other embodiments each video input thumbnail TN need not include merely a “captured frame” of the video content being presented on the corresponding video input VI but could include such video content in real time if the device 202 has the appropriate number of tuners. For example, if the device 202 has a tuner for each video input VI then the video content or lack thereof being presented on each video input can be displayed in a corresponding thumbnail in real time instead of in the form of captured frame.

Even though various embodiments and advantages of the present invention have been set forth in the foregoing description, the above disclosure is illustrative only, and changes may be made in detail and yet remain within the broad principles of the present invention. Moreover, the functions performed by the components 206-220 in the video display generating device 202 of FIG. 2 can be combined to be performed by fewer elements, separated and performed by more elements, or combined into different functional blocks. Also, one skilled in the art will understand suitable circuitry for forming the remote control 204 and the components 206-220 in the video display generating device 202. It should also be noted that the phrase “video content” as used herein is used broadly and corresponds to any type of video information and thus includes not only moving pictures such as for a movie or a television show but also includes still digital images such as from a digital camera or camcorder coupled to one of the video inputs VI of the device 202. Regarding the remote control 202, the find picture button 205, select button 224, and navigation control key 222 on the remote may take different forms in other embodiments of the present invention, with the specific form of each of these types of user input controls varying widely and with the functions for each of these controls being combined in other embodiments. Therefore, the present invention is to be limited only by the appended claims.

What is claimed is:

1. A method of selecting video content to be displayed from among a plurality of video inputs, the method comprising:
initiating a video input selection mode of operation;
simultaneously displaying video content currently being presented on all video inputs; and
selecting the video content to be displayed from among the displayed video content for all the video inputs.

2. The method of claim 1 wherein simultaneously displaying video content currently being presented on each video input comprises simultaneously displaying a plurality of video input thumbnails, each video input thumbnail displaying the video content of the corresponding video input.

3. The method claim 2 wherein the video content displayed in each video input thumbnail corresponds to a captured frame of the video content currently being presented on the corresponding video input.

4. The method of claim 3 further comprising occasionally capturing frames of the video content being presented to update the video content displayed in each video input thumbnail.

5. The method of claim 2 wherein each video input thumbnail further comprises text data indicating the video input corresponding to the thumbnail.

6. The method of claim 5 wherein at least one of the video input thumbnails further comprises data indicating additional information related to the corresponding video input.

7. The method of claim 6 wherein the additional information comprises data indicating that additional channels of video information are available from the corresponding video input.

8. The method of claim 1 wherein selecting the video content to be displayed from among the displayed video content for all the video inputs comprises:
generating navigation control signals;
highlighting the desired video content responsive to the navigation control signals;
generating video input selection signals;
selecting the video input corresponding to the highlighted video content responsive to the video input selection signals; and
displaying the video content for the selected video input.

9. The method of claim 1 wherein initiating the video input selection mode of operation comprises activating a find picture button.

10. The method of claim 1 wherein each video input comprises one of a standard analog, a digital, or an RF video input.

11. A video display generating device comprising a plurality of video inputs, each video input adapted to receive video content and the device being adapted to receive video input display and selection control signals, the device operable in a video input source selection mode responsive to the control signals to simultaneously display video content currently being presented on all video inputs and operable responsive to the control signals to select the video content from one of the video inputs and to display the selected video content.

12. The video display generating device of claim 11 wherein the control signals comprise wireless signals communicated to the device over a wireless communications link.

13. The video display generating device of claim 11 wherein the device comprises one of a television and a personal video recorder, and wherein when the device comprises a personal video recorder the device is further operable to record video content.

14. The video display generating device of claim 11 wherein the device is operable to simultaneously display a plurality of video input thumbnails, each video input thumbnail showing the video content of the corresponding video input.

15. The video display generating device of claim 14 wherein the device is further operable to a capture a frame of the video content currently being presented on each of the video inputs and is operable to resize each frame and display each resized frame as a corresponding video input thumbnail.

16. The video display generating device of claim 15 wherein the device occasionally captures additional frames for each video input to update the content displayed in the corresponding thumbnail.

17. The video display generating device of claim 11 wherein the control signals include navigation control signals and selection signals, wherein the device is operable to highlight the video content for a respective video input responsive to the navigation control signals, and wherein the device is operable to display only the highlighted video content responsive to the selection signals.

18. The video display generating device of claim 11 further comprising:
video input channel selection circuitry coupled to the video inputs, the circuitry operable to provide a video signal from a selected one of the video inputs on an output;
video digitizing circuitry coupled to the output of the video input channel selection circuitry to receive the video signal and operable to generate digital video data corresponding to the video signal;
a controller coupled to the digitizing circuitry to receive the digital video data, the controller operable to resize the digital video data to generate resized digital video data;
a frame buffer coupled to the controller and operable to store the resized digital video data; and
a display coupled to the frame buffer and operable to generate a video image using the resized digital video data stored in the frame buffer.

19. A remote control including an activation button, a selection button, and at least one navigation control button, the remote control operable responsive to the activation button being activated to generate a video input display signal containing information that is adapted to cause video content for all video inputs available to a user to be displayed, the remote control operable to responsive to the navigation control button to generate a navigation control signal that is adapted to cause video content associated with one of the video inputs to be highlighted, and the remote control further operable responsive to the selection button to generate a selection control signal that is adapted to cause only the highlighted video content to be displayed.

20. The remote control of claim 19 wherein the activation, selection, and navigation control buttons are all the same button.

21. The remote control of claim 19 wherein the activation button comprises a find picture button, the navigation control buttons comprise up, down, right, and left arrow buttons, and the selection button comprise a separate button on the remote control.

22. An audio-video system, comprising:
a video display generating device comprising a plurality of video inputs, each video input adapted to receive video content and the device being adapted to receive video input display and selection control signals, the device operable in a video input source selection mode responsive to the control signals to simultaneously display video content currently being presented on all video inputs and operable responsive to the control signals to select the video content from one of the video inputs and to display the selected video content; and
a remote control including at least one user input component, the remote control operable to generate the video input display and selection control signals responsive to each user input component being activated.

23. The audio-video system of claim 22 wherein the wherein the video display generating device comprises a television.

24. The audio-video system of claim 22 wherein the video display generating device is operable to simultaneously display a plurality of video input thumbnails, each video input thumbnail showing the video content of the corresponding video input.

25. The audio-video system of claim 24 wherein the video display generating device is further operable to a capture a frame of the video content currently being presented on each of the video inputs and is operable resize each frame and display each resized frame as a corresponding video input thumbnail.

26. The audio-video system of claim 25 wherein video display generating device occasionally captures additional frames for each video input to update the content displayed in the corresponding thumbnail.

27. The audio-video system of claim 22 wherein the control signals from the remote control include navigation control signals and selection signals, wherein the video display generating device is operable to highlight the video content for a respective video input responsive to the navigation control signals, and wherein the video display generating device is operable to display only the highlighted video content responsive to the selection signals.
